(19) United States
(12) Patent Application Publication
(10) Pub. No.: US 2010/0008561 A1
(43) Pub. Date: Jan. 14, 2010

(54) SYSTEM AND METHOD FOR AUTHENTICATING PRODUCTS AND/OR PACKAGES

(75) Inventors: Francesco Cino Matacotta, Bologna (IT); Fabio Biscarini, Bologna (IT); Massimillano Cavallini, Vergato (IT); Pablo Alberto Stoliar, Bologna (IT)

Correspondence Address: GREER, BURNS & CRAIN, 300 S WACKER DR, 25TH FLOOR, CHICAGO, IL, 60606, US

(73) Assignee: Scriba Nanotecnologie S.R.L., Bologna (IT)

(21) Appl. No.: 12/443,514

(22) PCT Filed: Oct. 4, 2006
(86) PCT No.: PCT/EP2006/009611

§ 371 Date: Mar. 30, 2009

(51) Int. Cl. G06K 9/00; G06F 15/00

(52) U.S. Cl. 382/143; 358/1.6; 348/161

(57) ABSTRACT

A system for authenticating products and/or packages, comprising a unit for acquiring primary configurations which represent meaningful images and for generating secondary configurations for the authentication marking of products and/or packages; a unit for applying the generated secondary configurations to a product and/or package; and a unit for recognizing the secondary configurations applied to the product and/or package. All the units are provided with means for mutual connection in an active configuration for transmitting digital data. A method for authenticating products and/or packages comprises the acquisition of primary configurations which represent meaningful images; the generation of secondary configurations for marking; the application of the generated secondary configurations to a product and/or package; and the recognition of the authenticity of the product and/or package.

### TECHNICAL FIELD

The present invention relates to a system and method for authenticating products and/or packages and to an authentication marking for products and packages.

### BACKGROUND ART

As is known, an increasing number of counterfeited products is currently introduced in the market. Such products often assume the exact appearance of the genuine product, and therefore a consumer in good faith may easily purchase a counterfeited product instead of purchasing a genuine one.

Counterfeiting relates both to the products proper and to their packages.

Applying a code or marking to a product or package which allows its certain and unique identification is an imperative now more than ever. There is already a very lively industry that deals indeed with the production of systems for marking products with the aim of documenting their authenticity.

Several systems for marking products for authentication are known and used, such as holograms, inks, optical writing codes, and others.

Writing codes can comprise an elementary square structure which is provided with dots inserted in columns which are mutually perpendicular and allows direct placement on the objects to be identified or certified, increasing their security against attempts at forgery and counterfeiting.

The writing systems used in production processes are traditional labeling, inkjet marking, laser etching, screen printing, holograms and others.

Despite the fact that marking configurations and methods are ever more sophisticated, the technological advancement of duplication devices, which are progressing continuously and rapidly and are also assisted by ever more powerful computers and ever more improved software, provides the means for copying and reproducing the original markings.

Authentication markings have also been devised which are more difficult to interpret and copy for counterfeiters and are generated by means of complex coding programs and provide a good level of security.

A first level of security can be provided with technologies for visible marking, which can be identified or recognized easily by a consumer as an integral part of the package. The next security level entails the use of processes for providing a marking which is invisible and/or has the appearance of a random image. Such processes usually can be used only by authorized personnel. This entails generally the use of tools which can read the information and achieve instant verification. Only a small number of people (employees of the security provider or of the original or authorized manufacturer) should be aware of the existence of such elements and they should be disclosed only at verification time.

This development has been allowed also by markings provided by means of inks which are invisible under normal light but can be read with particular kinds of lighting, such as ultraviolet light.

Highly sophisticated marking configurations obtained by encoding, having the appearance of random patterns, require however highly advanced software programs to generate them and the processing of information and data in such quantities as to require very powerful and expensive computers.

In such cases it is also necessary to transfer and store a large quantity of information in order to generate and recognize the random patterns. This affects considerably the complexity and difficulty of use on the part of operators, who generally must be experts, and not least the costs of the operating systems and data transmission systems. The markings are recognized by means of devices which necessarily have a very high performance and high price.

### DISCLOSURE OF THE INVENTION

The aim of the present invention is to eliminate the drawbacks noted above in known types of marking system for authentication by providing a system, a method and a marking for authenticating products and/or packages which are capable of providing marking configurations which are difficult or even impossible to detect and reproduce by potential counterfeiters and can also be recognized for quick and unequivocal authentication of the genuine products.

Within this aim, an object of the invention is to provide a system and a method for authenticating products and/or packages which use devices and components which are commercially available and have low complexity and costs.

Another object of the invention is provide a system and a method for authenticating products and/or packages which allow easy use on the part of a user even if he is not an expert in electronics and/or computer systems and can be operated rapidly with choices and criteria which cannot be accessed by unauthorized personnel.

Another object of the invention is to provide the flexible and coordinated use of marking devices and of devices for recognizing the markings, even arranged at a great distance from each other, in order to distinguish genuine articles from counterfeited ones.

Still another object of the invention is to provide a system, a method and a marking for authenticating products and/or packages which do not damage or reduce the integrity and aesthetics of the marked products.

This aim and these and other objects which will become better apparent hereinafter are achieved by a system for authenticating products and/or packages, according to the invention, comprising a unit for acquiring primary configurations which represent meaningful images and for generating secondary configurations for the authentication marking of products and/or packages, a unit for applying the generated secondary configurations to a product and/or package, and a unit for recognizing the secondary configurations applied to the product and/or package, said acquisition and generation, application, and recognition units being provided with means for mutual connection in an active configuration for transmitting digital data.

A method for authenticating products and/or packages, according to the invention, comprises the steps of: acquiring, in a unit for acquiring and generating marking configurations, primary configurations which represent meaningful images; generating, in said unit for acquiring and generating marking configurations, secondary configurations for the authentication marking of products and/or packages; applying the generated secondary configurations, by means of a unit for applying marking configurations, to a product and/or package; and recognizing the authenticity of the product and/or package by means of a unit for recognizing the configurations applied to the product and/or package.

### BRIEF DESCRIPTION OF THE DRAWINGS

Further characteristics and advantages of the invention will become better apparent from the description of a preferred but not exclusive embodiment of the system and method for authenticating products and/or packages, illustrated by way of non-limiting example in the accompanying drawings, wherein:

FIG. 1 is a schematic view of the system for authenticating products and/or packages according to the invention;

FIG. 2 is a flowchart of the steps of the method for authenticating products and/or packages, according to the invention; and

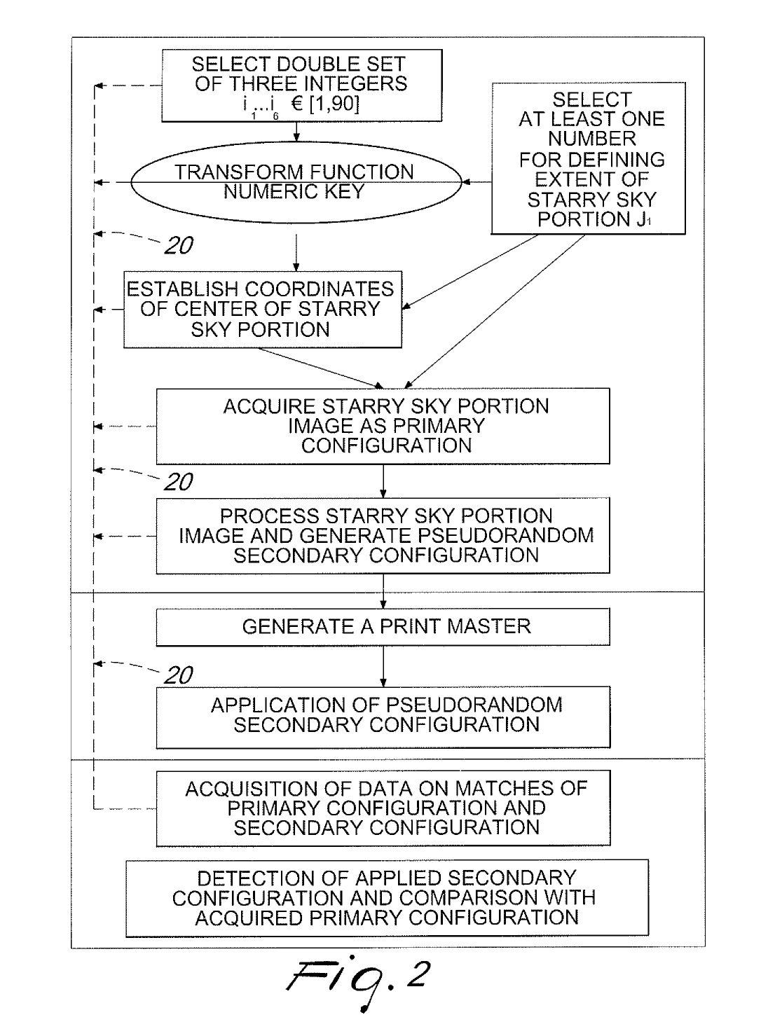

FIG. 3 is an example of conversion of primary configuration into secondary configuration according to the invention.

### WAYS OF CARRYING OUT THE INVENTION

With reference to the figures, the system for authenticating products and/or packages P, according to the invention, comprises a unit 1 for acquiring primary configurations 16 which represent meaningful images and for generating secondary configurations 17 for authentication marking, a unit 2 for applying the generated secondary configurations 17 to a product and/or package P, and a unit 3 for recognizing the secondary configurations 17 applied to the product and/or package P. The acquisition and generation unit 1 and the application and recognition units are provided with means 7 for mutual connection in the active configuration for the transmission of digital data 20.

The acquisition and marking generation unit 1 comprises an electronic computer 14, for example a personal computer PC, which is provided with means for receiving/transmitting digital data, such as modems, systems for remote connection with and via the Internet and/or cellular telephones, et cetera, ports and/or readers for digital data, and is provided with a software 5 which is capable of generating the secondary configurations 17 for marking. Such secondary configurations are advantageously but not exclusively in the form of pseudorandom configurations, i.e., without an apparent meaning for the reader who is not informed, and processed on the basis of primary configurations 16 which are representative of meaningful images.

The unit 2 for applying the secondary configurations 17 is provided with a device 10 for transferring the secondary configurations 17, which also can be controlled by means of an electronic computer 8, 15, preferably of the PC type. The transfer device 10 can be constituted, according to the marking requirements and to the type of product and/or package P to be marked, by one or more printing means, such as laser printers or inkjet printers or ink sublimation printers, by lithography means, screen printing means, laser etching means or other known means suitable for the indelible marking of surfaces made of fabric, paper, glass, metal, plastics, food products, or others. When an inkjet printer is used, the pseudorandom secondary configuration 17 can be printed with ink provided with the addition of fluorescent substances, such as oligomers of thiophene which can be excited by UV lighting, and therefore in this case it is not eye-detectable under normal natural or artificial light.

The unit 3 for recognizing the configurations applied to the product and/or package comprises an image detector 13, for example a digital reader, such as a digital camera or a digital video camera or other similar device. The digital detector or reader 13 can be connected to an electronic computer 12 for processing digital data, which is adapted to interpret the digital image of the received secondary configuration 17, compare it with the data on the primary image 16 received from the unit 1, and recognize by authentication the genuine markings.

It is further possible to provide the unit 3 with a warning system, which displays or emits a warning message when a false marking is detected. In order to read secondary configurations 17 applied with additive-containing, fluorescent and/or invisible inks, the unit 3 is also provided with UV light source 11. The use of non-toxic inks, compatible with foodstuffs, is also considered.

The means 7 for mutually connecting the units 1, 2, 3 can be of any type that is suitable and compatible with the types of computers that are used and suitable for remote connection and/or connection over the Internet in order to download, receive and transmit data 20, in the clear or encrypted.

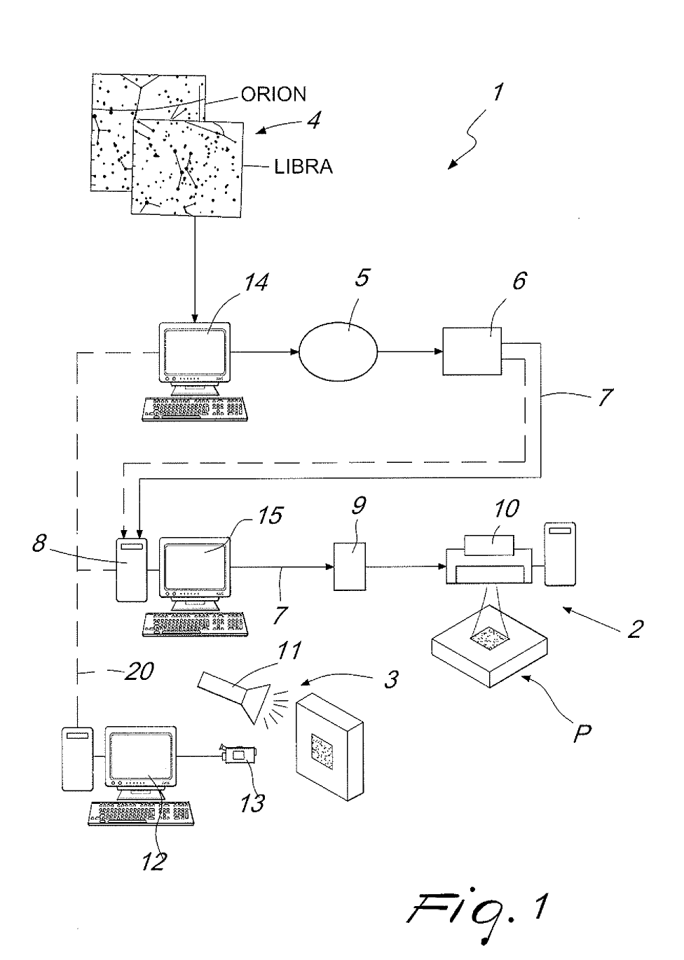

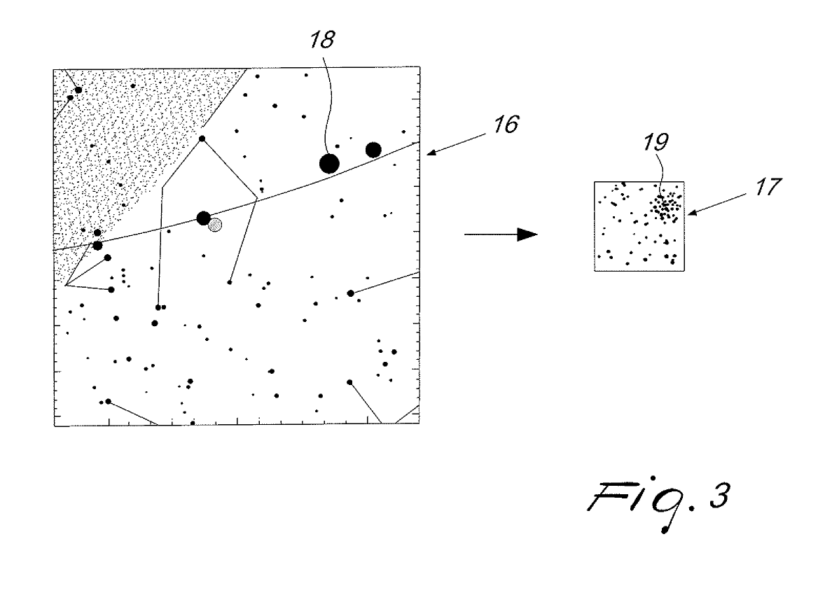

In a preferred embodiment of the invention, the primary configurations 16 that represent a meaningful image are constituted by star charts or portions of star charts, selected and processed on the basis of a numeric key, which correspond to a specific position in space and time of a portion of the starry sky. Star charts are, for example, available on data media (such as CDs, DVDs or others) or can be downloaded from specialized Internet sites and represent the position of the stars in a region of space at a certain time. FIGS. 1 and 3 illustrate examples of star charts of portions of sky which include for example constellations Orion, Scorpio or Libra, as they were detectable two hours before the new moon closest to Nov. 17, 1993.

The software 5 of the electronic computer 14 of the unit 1 for acquiring and generating marking configurations is provided with transform functions. The numeric key might correspond to, be, or be able to generate, an indirect representation of the image of said portion of starry sky by means of said transform functions.

In the particular variation of the system that is selected, a portion of starry sky can be selected in which the coordinates of the center of the image correspond to a double set of three integers which can be set at will. The extent of the portion also might be selected by setting one or more angular values. The sets of three integers are selected for example among integers ranging from 1 to 90 and the angular values are selected so as to range from 1 to 10°.

The unit 1 for acquiring and generating marking configurations can conveniently comprise image processing means 6, which in a preferred but not exclusive variation of the invention are constituted by the software of the electronic computer 14, which is configured so that it is suitable to adapt the contrast and dimensions of dots 19, which are generated so as to correspond to bright objects 18 contained within the image 16 (FIG. 3) of the portion of starry sky and constitute as a whole the pseudorandom configuration 17 as a pattern of dots 19 having a pseudorandom appearance on a uniform background. Preferably, the pseudorandom pattern is a black-and-white image constituted by dots whose size is set between 10 and 300 micrometers, which once applied to the product and/or package P, depending on the type of ink used, is either visible in normal light conditions, partially visible in normal light conditions, or is invisible in normal light but is visible when lit with special light, such as UV light.

The pseudorandom secondary configuration 17 can be applied directly to a product or package or to a label or tag of a known type or manufactured specifically, which can be attached to the product and/or package P.

The method used according to the invention to authenticate products and/or packages comprises steps for acquiring, in the unit 1 for acquiring and generating marking configurations, the primary configurations 4, 16 which represent meaningful images; for generating, in the unit 1, secondary configurations 17 for marking; for applying the generated secondary configurations 17, by means of the unit 2 for applying marking configurations, to the product and/or package P; and for recognizing the authenticity of the product and/or package by means of the unit 3 for recognizing the applied configurations.

Preferably, star charts or portions of star charts selected at random are acquired.

Acquisition entails selecting the double random set of three integers, preferably ranging from 1 to 90; modifying, by means of the transform functions of the software 5 of the electronic computer 14 of the unit 1, the double set of three integers that has been selected, on the basis of the numeric key, in order to obtain coordinates of an image center of a portion of starry sky 16; defining, by random selection, at least one other additional number, which corresponds to an angular value, said additional number being selected preferably so that the extent of the image of the portion of starry sky 16 that is selected ranges from 1 to 10°; and acquiring from a source of star charts the image of the portion of starry sky 16 that correspond to the selected coordinates and defined extent. The step for processing the acquired images 16 of the portion of starry sky is performed by adapting the contrast and setting the size of dots that correspond to bright objects contained in the image of the portion of starry sky. The secondary configuration 17 is thus generated, preferably but not exclusively in black and white, as a pseudorandom configuration formed by the pattern of the dots 19 on a uniform background.

The step for generating secondary configurations 17 for marking comprises generating a digital image which generates a print master 9 which can be defined, depending on the type of applicator 10 that is used, as a screen for lithography, screen printing, direct digital printing or others.

The step for recognizing the authenticity of the product and/or package, by means of the unit 3 for recognizing the secondary configurations applied to the product and/or package, entails that the recognition unit 3 has acquired data 20 necessary to determine the selected primary configuration 16, such as the numeric key, and comprises lighting with UV light, if the marking has been made with ink provided with additives, the secondary configurations applied to the product and/or package, detecting the image of the illuminated configuration, and comparing, by using the numeric key, the detected secondary configuration with the image 4, 16 of the portion of starry sky acquired by the unit 1.

The invention also includes the authentication marking of products and/or packages constituted, in its preferred but not exclusive embodiment, by the pseudorandom secondary configuration 17 which corresponds to a primary configuration 4, 16 which represents meaningful images of star charts or portions of star charts selected at random which correspond to a specific position in time and space of a portion of starry sky.

Among the advantages of the invention, attention is called to the simplicity with which the primary configurations are generated, without requiring complex programs or special machines for processing the necessary data. In view of the extremely large number of possible choices of primary configurations and of the ease with which they are transposed into pseudorandom configurations without apparent meaning, it is very unlikely, or even impossible, for the marking to be reproduced in all its details so that it can be misleading for the detection system.

It is further possible to ensure levels of security that cannot be achieved with other systems, since it is possible to keep the operator-printer of the dot pattern unaware of the numeric key that is used and inform only the operator of the recognition unit. The transform function is necessarily known only to the supervisor of the system.

In practice it has been found that the described system and method for authenticating products and/or packages are capable of providing a marking with an extremely high level of security and reliability, which practically eliminates the possibility of imitation thereof and allows to identify genuine and counterfeited products in a manner which is simple for the user and inexpensive and can thus be applied to any product, even a mass-produced and/or low-cost product.

The described invention can be applied in the most disparate industrial and nonindustrial fields, such as the agroalimentary, textile, shoemaking, electronic field, in general for consumer goods and also for spare parts or others.

The system thus conceived is susceptible of numerous modifications and variations, all of which are within the scope of the inventive concept as expressed in the appended claims.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-30. (canceled)

31. A system for authenticating products and/or packages, comprising:
a unit for acquiring primary configurations which represent meaningful images and for generating secondary configurations for the authentication marking of products and/or packages;
a unit for applying the generated secondary configurations to a product and/or package; and
a unit for recognizing the secondary configurations applied to the product and/or package, said acquisition and generation, application, and recognition units being provided with means for mutual connection in an active configuration for transmitting digital data.

32. The system according to claim 31, wherein said unit for acquiring and generating marking comprises an electronic computer provided with means for receiving/transmitting digital data and with software capable of generating said secondary configurations for the authentication marking of a product and/or package in the form of pseudorandom configurations processed on the basis of the primary configurations which are representative of meaningful images.

33. The system according to claim 31, wherein said unit for applying the secondary configurations for authentication marking comprises a device for transferring said secondary marking configurations to products and/or packages, said transfer device being controllable by means of an electronic computer.

34. The system according to claim 33, wherein said transfer device comprises one or more among printing means, lithography means, screen printing means, laser etching means or other means suitable for the indelible marking of surfaces.

35. The system according to claim 34, wherein said printing means comprise digital printing means and in particular means for inkjet printing or ink sublimation printing.

36. The system according to claim 31, wherein said unit for recognizing the configurations applied to the product and/or package comprises a digital reader, such as a digital camera or a digital video camera or other similar device, said digital reader being connected to an electronic computer for processing digital data which is adapted to recognize pseudorandom configurations for authentication.

37. The system according to claim 31, wherein said unit for recognizing the marking configurations comprises a UV light source.

38. The system according to claim 33, wherein said electronic computers are of the PC type.

39. The system according to claim 31, wherein said means for connecting said units are of the type with remote connection and/or connection over the Internet.

40. The system according to claim 31, wherein said primary configurations which represent a meaningful image are constituted by star charts or portions of star charts selected according to a numeric key and corresponding to a specific position, in time and space, of a portion of starry sky.

41. The system according to claim 40, wherein said software of the electronic computer of the unit for acquiring and generating marking configurations is provided with transform functions, said numeric key being an indirect representation of the image of said portion of starry sky via said transform functions.

42. The system according to claim 40, wherein said portion of starry sky has an image center whose coordinates correspond to a double set of three integers which are set at will and an extent which is selected by setting one or more angular values.

43. The system according to claim 42, wherein said sets of three integers are selected among integers ranging from 1 to 90 and said angular values are selected so as to range from 1 to 10°.

44. The system according to claim 32, wherein said unit for acquiring and generating marking configurations comprises image processing means.

45. The system according to claim 44, wherein said image processing means are constituted by the software of the electronic computer of the unit for acquiring and generating marking configurations, which is suitable to adapt the contrast and size of dots which correspond to bright objects contained in the image of the portion of starry sky in order to generate said pseudorandom configuration as a pattern of pseudorandom dots on a uniform background.

46. The system according to claim 45, wherein said pseudorandom pattern forms a black-and-white image constituted by dots whose dimensions are set between 10 and 300 micrometers.

47. The system according to claim 32, wherein said secondary pseudorandom configuration applied to a product and/or package is visible in conditions of normal light, partially visible in conditions of normal light, or visible only after UV lighting.

48. The system according to claim 47, wherein said unit for applying configurations comprises an inkjet printer, the pseudorandom secondary configuration being printed with ink containing fluorescent substances.

49. The system according to claim 48, wherein said ink receives the addition of oligomers of thiophene which can be excited under UV lighting.

50. The system according to claim 47, wherein said pseudorandom secondary configuration can be applied directly to a product, to a package or to a label or tag which can be attached to a product and/or package.

51. A method for authenticating products and/or packages, further comprising the steps of:
acquiring, in a unit for acquiring and generating marking configurations, primary configurations which represent meaningful images;
generating, within said unit for acquiring and generating marking configurations, secondary configurations for the authentication marking of products and/or packages;
applying the generated secondary configurations, by means of a unit for applying marking configurations, to a product and/or package; and
recognizing the authenticity of the product and/or package by means of a unit for recognizing the configurations applied to the product and/or package.

52. The method according to claim 51, wherein said acquisition step comprises the acquisition, as primary configurations which represent meaningful images, of star charts or portions of star charts which are selected at random and correspond to a specific position, in time and space, of a portion of starry sky.

53. The method according to claim 52, wherein said step for acquiring star charts or portions of star charts comprises:
selecting a double random set of three integers;
modifying, by means of transform functions of the software of the electronic computer of the unit for acquiring and generating marking configurations, said selected double set of three integers on the basis of a numeric key in order to obtain coordinates of a center of an image of a portion of starry sky;
defining, by means of the random choice of at least one other additional number which corresponds to an angular value, an extent of the image of the selected portion of starry sky; and
acquiring from a source of star charts the image of the portion of starry sky that corresponds to the selected coordinates and to the specific extent.

54. The method according to claim 53, wherein said sets of three integers are selected among integers ranging from 1 to 90 and said angular values are defined from 1 to 10°.

55. The method according to claim 51, wherein said step for generating secondary configurations for marking comprises the processing of the acquired images of the portion of starry sky by adapting the contrast and setting of the size of dots which correspond to bright objects contained in the image of the portion of starry sky and generating said secondary configuration as a pseudorandom configuration formed by a pattern of said dots on a uniform background.

56. The method according to claim 55, wherein said image processing step comprises forming said pseudorandom pattern in black and white, the size of the dots being set between 10 and 300 micrometers.

57. The method according to claim 51, wherein said step for generating secondary configurations for marking comprises generating a digital image which generates a print master.

58. The method according to claim 55, wherein said step for applying the generated secondary configurations comprises printing the secondary configurations on products and/or packages with inks which include fluorescent substances which can be excited under UV light.

59. The method according to claim 58, wherein the step of recognizing the authenticity of the product and/or package, by means of the unit for recognizing the secondary configurations applied to the product and/or package, comprises:
illuminating with UV light the secondary configurations applied to the product and/or package;
detecting the image of the illuminated configuration;
comparing, by using the numeric key, the acquired secondary configuration with the image of the portion of starry sky acquired by the unit for acquiring and generating marking configurations.

60. An authentication marking for products and/or packages, constituted by a pseudorandom secondary configuration which corresponds to a primary configuration which represents meaningful images of star charts or portions of star charts selected randomly and corresponding to a specific position, in time and space, of a portion of starry sky, the marking being generated and applied with the system according to claim 31.
